(19) United States
(12) Patent Application Publication
(10) Pub. No.: US 2007/0024818 A1
(43) Pub. Date: Feb. 1, 2007

(54) Projector

(75) Inventors: Chih-Chung Yang, Miao Li County (TW); Hua-Wen Fan, Miao Li County (TW)

Correspondence Address: BIRCH STEWART KOLASCH & BIRCH, PO BOX 747, FALLS CHURCH, VA, 22040-0747, US

(73) Assignee: Coretronic Corporation

(21) Appl. No.: 11/493,694

(22) Filed: Jul. 27, 2006

(30) Foreign Application Priority Data
Jul. 29, 2005 (TW) 94125834

(51) Int. Cl. G03B 21/18

(52) U.S. Cl. 353/57

(57) ABSTRACT

A projector having an optical engine module is disclosed. The projector has an optical engine module, a lamp module, and a fan and is disposed on the substrate. The lamp module is used for generating a light beam and reflecting the light beam to the optical engine module. The optical engine module comprises an invisible light filter, a color wheel, a light valve, and a projection lens. The fan is used for generating airflow to the lamp module.

### (1) FIELD OF THE INVENTION

The present invention relates to a projector, and more particularly to a projector constructed by a plurality of modular components.

### (2) DESCRIPTION OF THE PRIOR ART

A projector becomes an important display tool due to capabilities of large display and portability.

Generally, a conventional projector comprises a case, an optical engine module, a lamp module, a fan, and a power supply system. The optical engine module, the lamp module, the fan, and the power supply system are disposed in the case of the conventional projector.

Each of components for constructing the optical engine module, the lamp module, the fan, and the power supply system is individual and has to be tested after being manufactured. The optical engine module, the lamp module, the fan, and the power supply system have to be tested after disposing in the case. In this way, the components of the conventional projector have to be tested before disposing in the case and after disposing in the case.

The components involved in optical transmission and heat dissipation capability as the lamp module, the optical engine module, the fan, etc. need to be tested precisely. However, frequent tests make not only the manufacturing process be more complicated but also increase a possibility of defect.

Therefore, a goal of the present invention is to solve the drawbacks in the conventional projector.

### SUMMARY OF THE INVENTION

The present invention disclosed is directed to a projector and modular components used in the projector so as to simplify an assembling process while in manufacturing and decrease test times. In addition, it is more convenient to maintain or repair the modular components in the projector.

The present invention is a projector, which includes a case, a substrate, an optical engine module, a lamp module, a fan, a modular air guide, a modular power supply system, a modular amplifier, and a modular video player. The substrate, the optical engine module, the lamp module, and the fan are formed a module. The substrate is disposed within the case of the projector.

The optical engine module is disposed on the substrate and includes an invisible light filter, a color wheel, a light valve, and a projection lens.

The lamp module is disposed on the substrate and combined with the optical engine module to generate a light beam to project the light beam into the optical engine module.

The fan is disposed on the substrate and connected to the lamp module to generate airflow for dissipating heat from the lamp module.

To sum up, the present invention combines several components on the substrate to form a module, the components such as the optical engine module, the lamp module, and the fan. The present invention further includes modular components such as the modular air guide, the modular power supply system, the modular amplifier, and the modular video player. The module also can easily combine with the modular components to make that the assembling process is simpler, faster than the assembling process in the conventional projector and decrease the test times.

All the spirits and scope of the present invention will be understood by the detail and illustration described in following.

### BRIEF DESCRIPTION OF THE DRAWINGS

The present invention will now be specified with reference to its preferred embodiment illustrated in the drawings, wherein:

FIG. 1 illustrates a schematic view of a projector according to the present invention;

FIG. 2 illustrates an exploded schematic view according to a projector of the present invention;

FIG. 3 illustrates a schematic view of an optical engine module according to the present invention;

FIG. 4 illustrates a schematic view of a lamp module according to the present invention; and

FIG. 5 illustrates a schematic view of a power supply system according to the present invention.

### DESCRIPTION OF THE PREFERRED EMBODIMENT

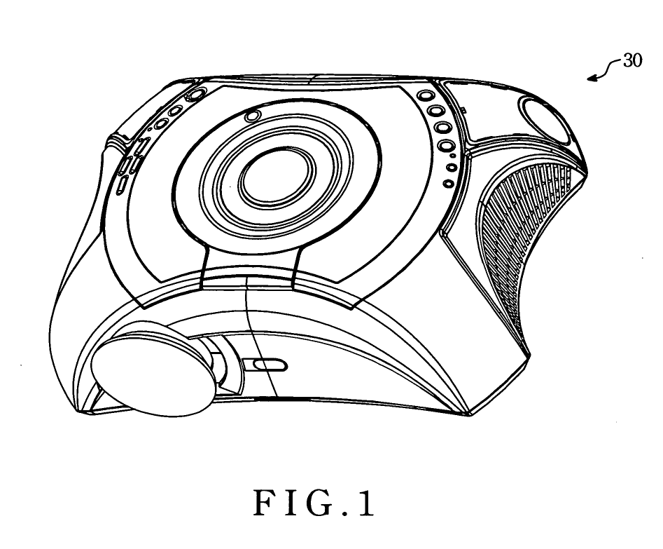

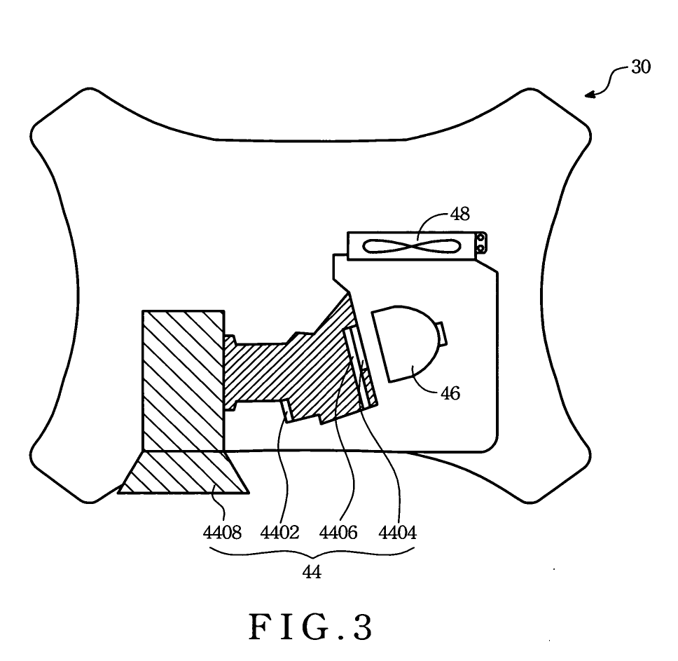

Please refer to FIGS. 1 to 3 showing a projector 30 of a preferred embodiment of the present invention. A projector 30 comprises a case 40, a substrate 42, an optical engine module 44, a lamp module 46, and a fan 48. The projector 30 further comprises modular components including a modular air guide 34, a modular power supply system 36, a modular amplifier 38 and a modular video player 39.

A case 40 of the projector 30 defines a space and has a top cover 4002, a base 4004, a back cover 4006, and a front cover 4008. The top cover 4002 includes a left side and a right side of the case 40. The left side and the right side of the case 40 have holes for dissipating heat from the lamp module 46. The back cover 4006 has varies outlets of video/audio terminals and the modular power supply system 36. The front cover 4008 has an opening for disposing a projection lens 4408 of the projector 30.

The substrate 42 is disposed within the case 40. Furthermore, the substrate 42 is detachable connected to an inner surface of the base 4004 of the case 40 and the optical engine module 44, the lamp module 46, and the fan 48 are disposed on the substrate 42.

A barricade 4202 is extended upward from the substrate 42 to divide the space of the case 40 into a first space and a second space. The first space is adjacent to the front cover 4008, and the second space is adjacent to the back cover 4006. The optical engine module 32, the lamp module 46, and the fan 48 are disposed in the first space. The modular power supply system 36 is disposed in the second space.

The lamp module 46 is connected to the optical engine module 44 for generating a light beam and then projecting the light beam into the optical engine module 44. The fan 48 is connected to the lamp module 46 and used for generating airflow to the lamp module 46 for dissipating heat from the lamp module 46.

That the optical engine module 44, the lamp module 46, and the fan 48 have to process optical alignment tests after disposing on the substrate 42 is better than that the components of the conventional projector have to be tested before disposing in the case and after disposing in the case. The embodiment is more helpful for product quality control and material management. Moreover, The optical engine module 44, the lamp module 46, and the fan 48 disposed on the substrate 42 and then the substrate 42 detachable connected to an inner surface of the base 4004 of the case 40 avoids an overheating problem caused by that the optical engine module, the lamp module, and the fan are disposed on a base of the case of the conventional projector.

The modular air guide 34 is connected to the lamp module 46 and operated in coordination with the fan 48 to guide the airflow flowing through the lamp module 46 and leading the airflow to a predetermined direction. In the embodiment, the modular air guide 34 leads the airflow to a lateral side of the case 40 of the projector 30 so as to prevent the airflow flowing to the front cover 4008 of the case 40 of the projector 30 and affecting quality of images. In addition, the modular air guide 34 is covered the lamp module 46 to prevent a light leakage and control noise from the fan 48 leaking out of the projector 30.

The substrate 42 and the barricade 4202 are made of metal material and used for stopping an Electromagnetic Interference (EMI) in the projector 30. The projector 30 further comprises a metal sheet member 45. The metal sheet member 45 is disposed above the modular air guide 34, the optical engine module 44, and the fan 48. The substrate 42, the barricade 4202, and the metal sheet member 45 are used for stopping the EMI from the internal of the projector 30.

Besides, integrating a printed circuit board 43 with the modular power supply system 36 of the projector 30 is convenient for assembling and replacing the printed circuit board 43.

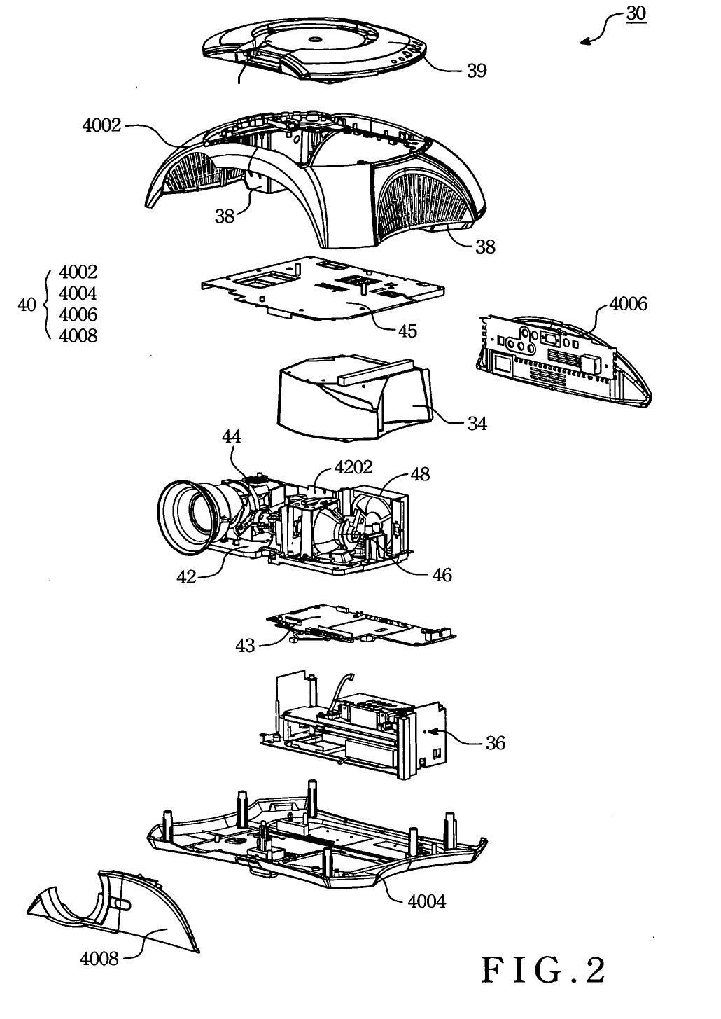

The projector 30 further has a modular amplifier 38 disposed on two opposite inner surfaces of the top cover 4002. In the embodiment, the modular amplifier 38 is disposed on two opposite sides of a rear end of the top cover 4002 as shown in FIG. 2. Therefore, the modular amplifier 38 is disposed firmly on the top cover 4002 while the top 4002 and the base 4004 are assembling together without the back cover 4006 and the front cover 4008. The modular amplifier 38 promotes an amplifying quality of video voice due to predetermined positions of the amplifier 38.

The modular video player 39 for playing a digital video disc (DVD). The modular video player 39 corresponding to the top cover 4002 is detachable disposed on the case 40 to provide image data. The modular video player 39 connects to the top cover 4002 in order to provide image data. More detail, the top cover 4002 has an opening, which is covered by the metal sheet member 45. An edge of the opening fits with the modular video player 39 so that dismantling and fabricating processes of the modular video player 39 are convenient and it is also convenient for the modular video player 39 to combine with the opening of the top cover 4002.

The optical engine module 44 further has an invisible light filter 4404, a color wheel 4406 a light valve 4402, and the projection lens 4408.

The invisible light filter 4404 is disposed on an optical transmission of the light beam from the lamp module 46 and used for filtering out infrared and ultra-violet (UV) light beam of the light beam from the lamp module 46 and then for projecting a visible light beam toward the color wheel 4406. The color wheel 4406 is disposed on an optical transmission of the visible light beam for filtering the visible light beam and then for projecting the visible light beam with specific primary colors onto the light valve 4402. The light valve 4402 is disposed on an optical transmission of the visible light beam with specific primary colors for reflecting the visible light beam with specific primary colors into an imaging beam.

The projection lens 4408 is disposed on an optical transmission of the imaging light beam for projecting the imaging light beam from the light valve 4402 onto a screen. Besides, the optical engine module 44 also includes a plurality of lens sets (not shown) for reflecting and refracting light to direct the light beams to the light valve 4402 and the projection lens 4408. The lens sets belong to prior arts and may not be described any further hereinafter.

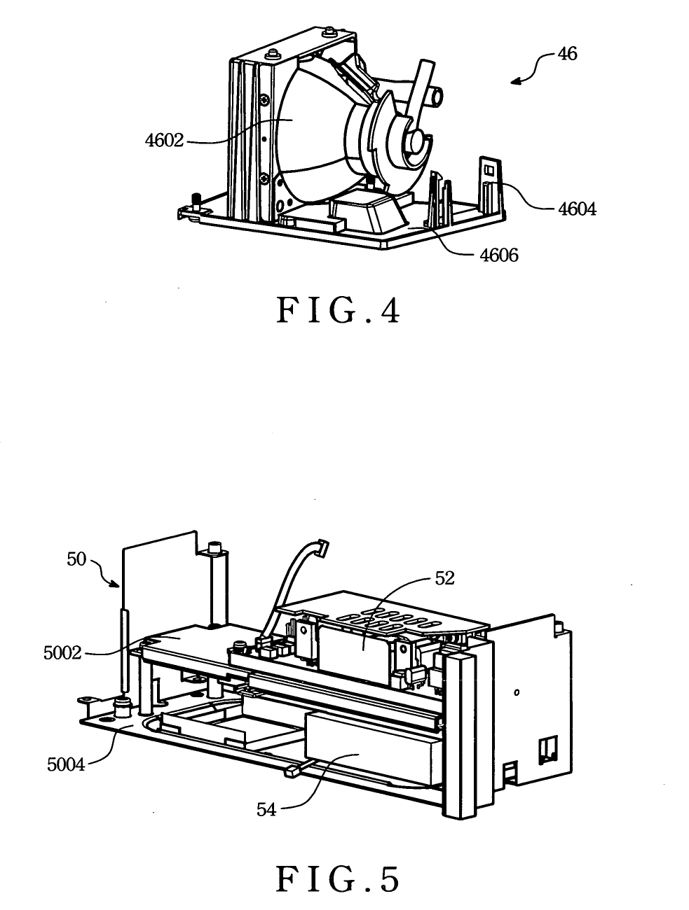

Please refer to FIG. 4. The lamp module 46 comprises a lamp 4602, a power supply connector 4604, and a lamp holder 4606.

The lamp 4602 is a light source. The power supply connector 4604 electrically connects to the lamp 4602 for transiting electrical power to the lamp 4602 and makes the lamp 4602 generate the light beam after the power supply connector 4604 is receiving the electrical power from a power supply external to the lamp module 46.

The lamp 4602 and the power supply connector 4604 are disposed on the lamp holder 4606. The lamp holder 4606 is disposed on the substrate 42. In this way, the lamp module 46 is easily to replace and fabricate, and becomes one of the modular components in the projector 30.

Please refer to FIG. 5. The projector 30 further comprises the modular power supply system 36. The modular power supply system 36 further has a frame 50, a first power supply substrate 5002, a second power supply substrate 5004, a lamp power supply 52 and a system power supply 54.

The frame 50 is disposed nearby the substrate 42. The first power supply substrate 5002 and the second power supply substrate 5004 are disposed on the frame 50. The second power substrate is disposed below the first power supply substrate. The frame 50 and the substrate 42 are placed next to each other on a rear part of an internal of the projector 30.

The lamp power supply 52 is disposed on the first power supply substrate 5002, and the system power supply 54 is disposed on the second power supply substrate 5004, then the modular power supply system 36 is formed. It is more convenient that the lamp power supply 52 and the system power supply 54 are arranged inside the projector 30.

As a conclusion, several components of the embodiment dispose on the substrate 42 to form a module, the components such as the optical engine module 44, the lamp module 46, and the fan 48. The module also can easily combine with the modular components including the modular air guide 34, the modular power supply system 36, the modular amplifier 38, and the modular video player 39 to make the assembling process much simpler and faster and decrease test times. In addition, the present invention makes repair and replacement of defective components easier and also makes the use of projector 30 be more accommodating. Furthermore, a modular component design of the present invention has an advantage that replacing the case 40 has no need to change inner components within the case 40 so that the projector 30 has extremely versatile appearances.

While the present invention has been particularly shown and described with reference to a preferred embodiment, it will be understood by those skilled in the art that various changes in form and detail may be without departing from the spirit and scope of the present invention.

We claim:

1. A projector comprising:
a case;
a substrate being disposed within the case;
an optical engine module being disposed on the substrate;
a lamp module being disposed on the substrate and combined with the optical engine module for generating a light beam and projecting the light beam into the optical engine module; and
a fan being disposed on the substrate for generating airflow to the lamp module,
whereby the optical engine module, the lamp module, and the fan are disposed on the substrate to form a module.

2. The projector of claim 1, wherein the substrate is detachable connected to a bottom surface of the case.

3. The projector of claim 1, wherein the optical engine module further comprises:
an invisible light filter disposed on an optical transmission of the light beam from the lamp module for filtering out infrared and ultra-violet (UV) light beam of the light beam and then for projecting a visible light beam;
a color wheel disposed on an optical transmission of the visible light beam for filtering the visible light beam and then for projecting the visible light beam with specific primary colors;
a light valve is disposed on an optical transmission of the visible light beam with specific primary colors for reflecting the visible light beam with specific primary colors into an imaging beam; and
a projection lens disposed on an optical transmission of the imaging light beam for projecting the imaging beam from the light valve onto a screen.

4. The projector of claim 1, wherein the lamp module further comprises:
a lamp for generating the light beam; and
a power supply connector electrically connected to the lamp for transiting electrical power to the lamp from a power supply.

5. The projector of claim 4, wherein the lamp module further comprises a lamp holder disposed on the substrate, the lamp and the power supply connector are disposed on the lamp holder.

6. The projector of claim 1 further comprising a modular air guide connected to the lamp module and operated in coordination with the fan for leading the airflow from the fan to a predetermined direction.

7. The projector of claim 1, further comprising a modular power supply system, the modular power supply system comprising:
a frame disposed nearby the substrate;
a first power supply substrate disposed on the frame;
a second power supply substrate disposed on the frame and below the first power supply substrate;
a lamp power supply disposed on the first power supply substrate; and
a system power supply disposed on the second power supply substrate.

8. The projector of claim 1, wherein the case defines a space, a barricade is extended upward from the substrate to divide the space into a first space and a second space, the optical engine module, the lamp module, and the fan are disposed in the first space, a modular power supply system of the projector is disposed in the second space, the substrate and the barricade are made of metal material and used for stopping an Electromagnetic Interference (EMI) in the projector.

9. The projector of claim 1, further comprising a modular amplifier disposed on two opposite inner surfaces of a top cover of the case.

10. The projector of claim 9, further comprising a modular video player corresponding to the top cover and detachable disposed on the case to provide image data.
